(19) United States
(12) Patent Application Publication
(10) Pub. No.: US 2022/0267657 A1
(43) Pub. Date: Aug. 25, 2022

(54) DUAL PHASE CHANGE MATERIAL LIQUID SUSPENSION AND METHOD OF MAKING THE SAME

(71) Applicant: Packaging Technology Group, LLC, Fall River, MA (US)

(72) Inventors: William C. Blezard, Mattapoisett, MA (US); Muhammad Kashif Azeem, Waltham, MA (US); Nelson Landrau, Leominster, MA (US)

(73) Assignee: Packaging Technology Group, LLC, Fall River, MA (US)

(21) Appl. No.: 17/180,774

(22) Filed: Feb. 20, 2021

(51) Int. Cl. C09K 5/06

(52) U.S. Cl. CPC C09K 5/063; C09K 2205/104

(57) ABSTRACT

A dual PCM liquid suspension is formed by blending a liquid phase change material having a first phase change temperature, a microencapsulated phase change material having a second phase change temperature, a thickening agent, and a surfactant and heating the blended materials for a period of time to form a permanent liquid suspension. PCM liquid suspension behaves as a viscous liquid and may be filled in PCM bottles with conventional liquid filling equipment. The PCM liquid suspension may be preconditioned and stored at a single temperature.

### BACKGROUND OF THE DISCLOSURE

### Field of the Invention

The present disclosure relates to the shipping of temperature sensitive products, temperature-controlled product shippers, and phase change materials (PCMs). More specifically, the disclosure relates to a novel dual phase change material liquid suspension which is effective for maintaining a stable temperature profile between 6° C. and 37° C. for up to 24 hours while in transit.

### Background

Generally, in the prior art, phase change materials (PCM's) in the form of gel packs or gel bricks are used to heat or cool the interior of temperature-controlled product shippers. The heating or cooling profile of a product shipper is calculated based on the shape, volume and weight of the product being shipped, a desired target temperature or temperature range and a duration of temperature maintenance. A combination of different “frozen” or “heated” gel packs may then be strategically utilized to maintain the product at the target temperature or temperature range. Before use, the individual gel packs are preconditioned to a specific temperature. For example, in some cold chain applications, there may be two temperatures used: −20° C. and +5° C. The gel packs are preconditioned separately and are be stored separately and there is a significant amount of energy consumed in preconditioning the PCM materials at different temperatures. There is also a significant amount of waste generated in disposing of the conventional PCM bricks which are often discarded at the point of receipt.

Due to increasing demands from environmentally conscious customers and the public, there is a growing need to reduce energy consumed during preconditioning of the PCM materials and to recycle or reuse packaging materials in the logistics chain.

### SUMMARY OF THE DISCLOSURE

The present invention provides a unique temperature-controlled shipper which is specifically designed for shipping diagnostic blood sample vials which must remain at a temperature between 6° C. and 37° C. for up to 24 hours while in transit.

An exemplary temperature-controlled shipper includes identical mating PCM blow-molded containers or bottles which enclose and protect diagnostic blood sample vials. Identical mating clamshell insulating portions further enclose and protect the PCM bottles which in turn protect and hold the blood sample vials. Both the PCM bottles and clamshell insulating portions may be molded from plastic and may be re-used within the user's shipping and logistics chain.

In accordance with the exemplary embodiments, a dual-PCM liquid suspension is utilized in the PCM bottles and is preconditioned and stored at a single temperature. An exemplary dual phase change material suspension comprises a first phase change material in liquid form having a first phase change temperature and a second phase change material in microencapsulated form having a second phase change temperature. A thickening agent and a surfactant are also utilized to maintain the microencapsulated phase change material in the liquid suspension. The first and second phase change materials, the thickening agent and the surfactant are blended in a uniform homogenous mixture and heated for a period of time to permanently suspend the microencapsulated PCM within the liquid PCM. As noted above, the final PCM liquid suspension may then be pre-conditioned at a single temperature.

The first liquid phase change material may be selected from the group consisting of: water-based PCMs; plant-based organic PCMs, paraffin based PCMs and salt hydrate based PCM's. The second PCM material may comprise a plant-based organic PCM microencapsulated in an acrylic shell.

Accordingly, among the objects of the instant invention are a novel dual-PCM liquid suspension for use in PCM containers or bottles which can be preconditioned and stored at a single temperature thus reducing energy consumption and storage requirements.

Other objects, features and advantages of the invention shall become apparent as the description thereof proceeds when considered in connection with the accompanying illustrative drawings.

### BRIEF DESCRIPTION OF THE DRAWINGS

In the drawings which illustrate the best mode presently contemplated for carrying out the present invention:

FIG. 1 is an exploded view of an exemplary embodiment of a temperature-controlled shipper constructed in accordance with the teachings of the present invention;

FIG. 2 is a top view of the shipper;

FIG. 3 is a cross-sectional view thereof taken along line 3-3 of FIG. 2;

FIG. 4 is a perspective view of the shipper;

FIG. 5 is a cross-sectional view taken along line 5-5 of FIG. 4;

FIG. 6 is a perspective view of the internal phase change material container;

FIG. 7 is a top view thereof;

FIG. 8 is a perspective view of the insulated clamshell portion of the shipper; and

FIG. 9 is another perspective view thereof.

### DETAILED DESCRIPTION OF THE EXEMPLARY EMBODIMENTS

Certain exemplary embodiments will now be described to provide an overall understanding of the principles of the structure, function, manufacture, and use of the device and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present disclosure. Further, in the present disclosure, like-numbered components of the embodiments generally have similar features, and thus within a particular embodiment each feature of each like-numbered component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Further, to the extent that directional terms like top, bottom, up, or down are used, they are not intended to limit the systems, devices, and methods disclosed herein. A person skilled in the art will recognize that these terms are merely relative to the system and device being discussed and are not universal.

In one aspect, the present invention provides a unique temperature-controlled shipper 10 which is specifically designed for shipping diagnostic 2 ml blood sample vials 12 which must remain at a temperature between 6° C. and 37° C. for up to 24 hours while in transit.

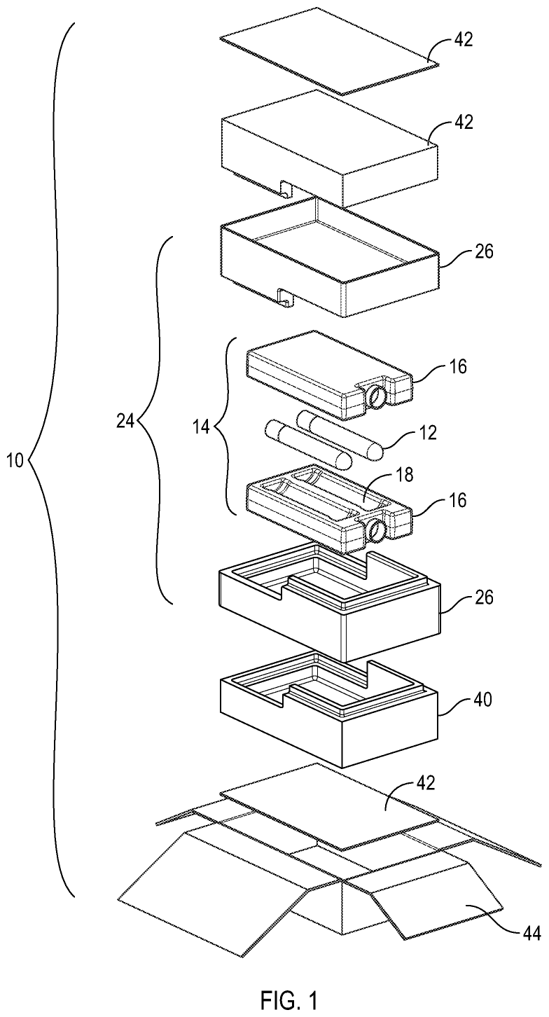

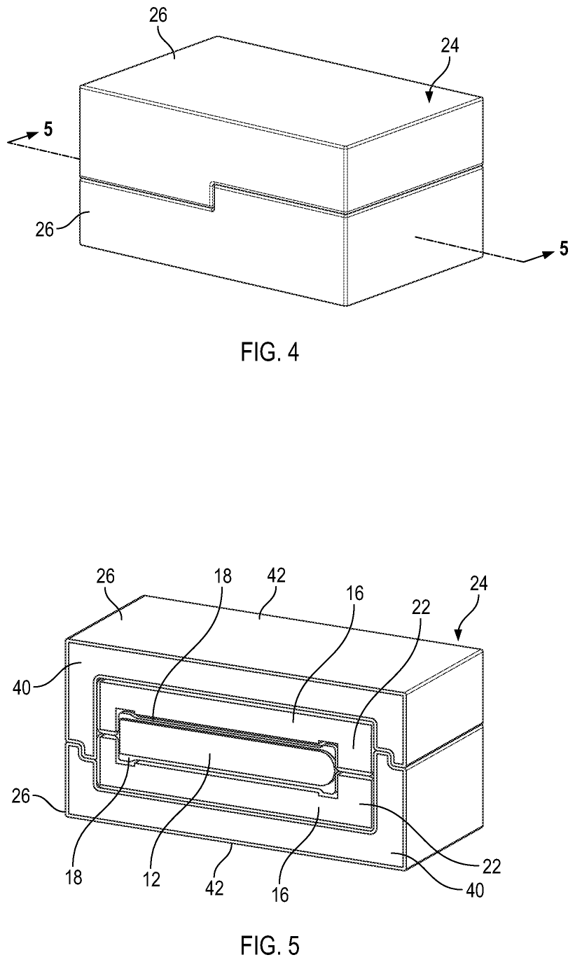

Referring now to the drawings, an exemplary embodiment of a temperature-controlled shipper 10 is illustrated in FIGS. 1-3. The shipper 10 includes a product receptacle 14 comprising identical mating PCM blow-molded containers or bottles 16 which enclose and protect one or more diagnostic blood sample vials 12. Briefly referring to FIGS. 4 and 5, the facing surfaces of the exemplary bottles 16 are contoured and shaped with semi-cylindrical cavities 18 to receive elongated cylindrical glass vials 12 for holding blood samples. The exemplary embodiment as illustrated and described should not be considered to limit the scope of potential use of the invention and it should be understood that other shapes and types of product containers could be equally employed. The containers 12 may include a filling port 20 at one end thereof and in use, they are filled with a phase change material liquid suspension 22 and sealed in a conventional manner with a cap or other sealing means. The exemplary PCM bottles 16 are noted herein to be identical which reduces molding costs and simplifies reuse and interchangeability, but different shapes may be used for the top and bottom portions as desired.

Turning back to FIGS. 1-3, an insulating case 24 comprising identical mating clamshell insulating portions 26 further encloses and protects the PCM bottles 16 which in turn protect and hold the blood sample vials 12. Both the PCM bottles 16 and clamshell container portions 26 may be molded from plastic and may be re-used within the user's shipping and logistics chain.

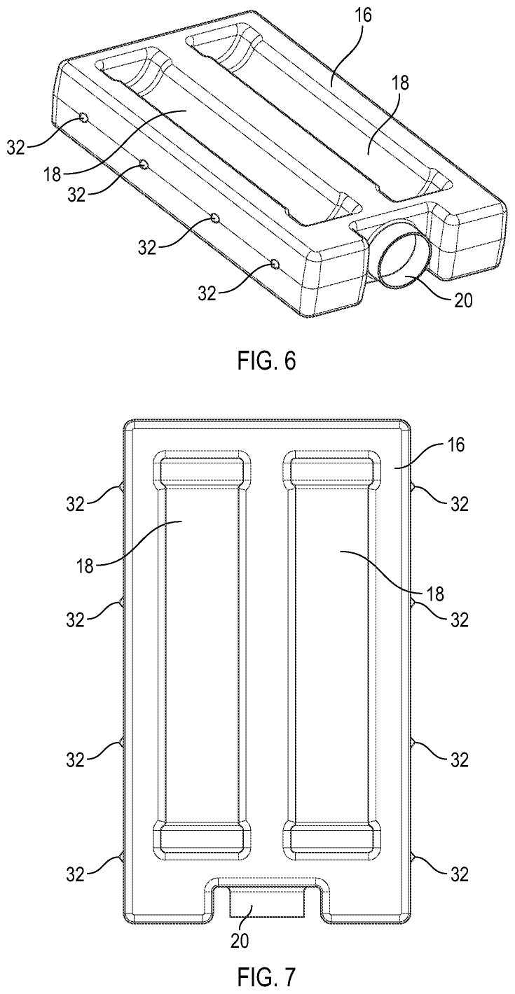

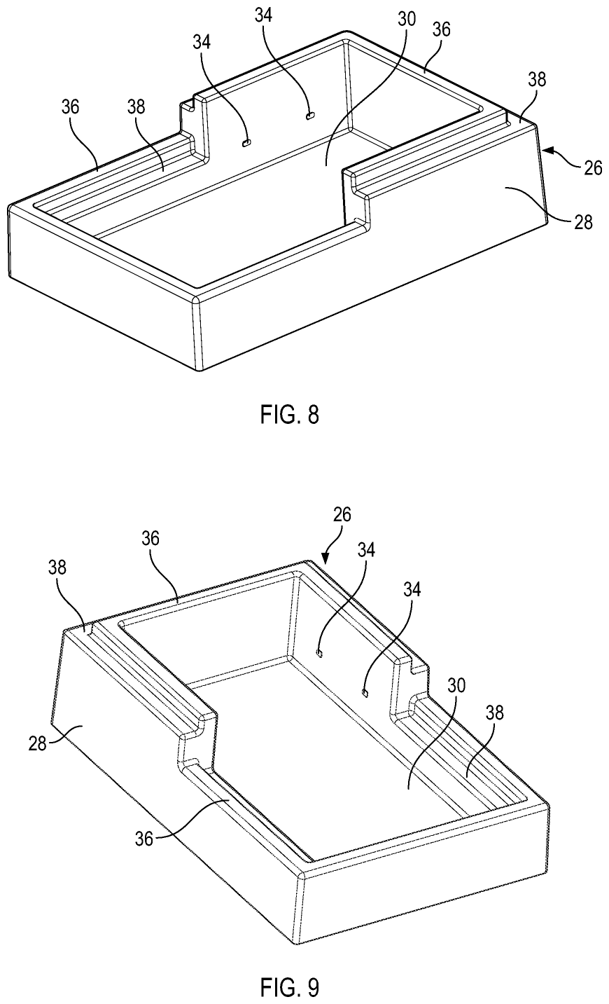

As best seen in FIGS. 1 and 5, each of the clamshell insulating portions 26 comprises a main body portion 28 having an interior surface contoured and shaped with a rectangular cavity 30 to receive a corresponding PCM bottle 16. Each clamshell portion 26 receives the corresponding PCM bottle 16 in frictional engagement, and to this end, the outer peripheral sidewalls of the PCM bottles 16 include raised locking nubs 32 which are snap received into complementary detents 34 in the inner sidewalls of the clamshell cavities 30. (See FIGS. 6-9 for the clear illustrations of the interfitting nubs and detents.)

In use, the PCM bottles 16 are snap received into a corresponding clamshell portion 26 and the blood sample vials 12 are simply placed into the bottle cavities 18.

To retain the two clamshell portions 26 together to define the insulating case 24, the outer peripheral edges of the clamshell portions 26 also include interfitting mating ridges 36 and shoulders 38 which are snap received together in a friction fit. Cross-sections of the entire shipper assembly 10 are illustrated in FIGS. 3 and 5.

Referring briefly back to FIG. 1, the rear surface cavity of the clamshell portions 26 are filled with an insulating foam material 40, or other suitable insulating material. A rear cover 42 is received over the rear cavity to retain the insulation 40 in place. The rear cover 42 may be edge sealed or may be snap received with the bottom of the clamshell main body with tab and slot structures (not shown).

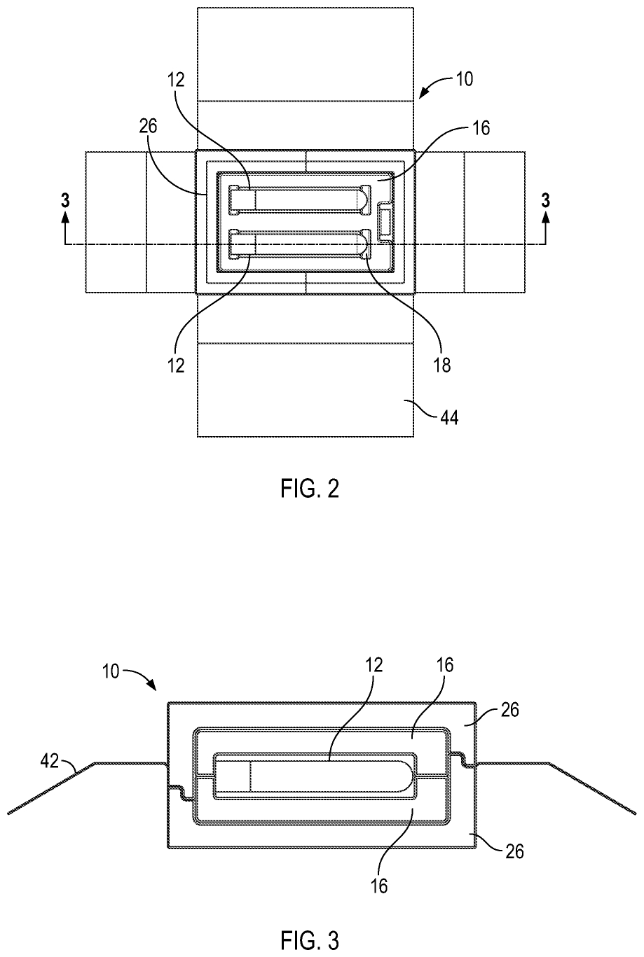

The assembled clamshell portions (See FIGS. 2 and 4) are then received into a cardboard outer box 44 for shipping.

The exemplary clamshell portions 26 are noted herein to be identical which reduces molding costs and simplifies reuse and interchangeability, but different shapes may be used for the top and bottom portions as desired.

Further in accordance with the present invention, the liquid PCM 22 comprises a novel dual-PCM liquid suspension which may be preconditioned and stored at a single temperature.

An exemplary dual phase change material liquid suspension 22 comprises a first phase change material in liquid form having a first phase change temperature and a second phase change material in microencapsulated form having a second phase change temperature.

A thickening agent and a surfactant may also utilized to maintain the microencapsulated phase change material in suspension in the liquid. The first and second phase change materials, the thickening agent and the surfactant may be blended in a uniform homogenous mixture and then heated for a period of time to permanently suspend the microencapsulated PCM within the liquid PCM.

As noted above, once the PCM material is in final suspended form, it behaves as a viscous liquid and may be dispensed into the PCM bottles using conventional filling equipment. Once filled, the PCM bottles may be pre-conditioned at a single temperature.

The first phase change material may be selected from the group consisting of: water-based PCMs; plant-based organic PCMs, paraffin based PCMs and salt hydrate based PCM's. In particular, the liquid PCM may comprise an organic ester, such as Crodatherm 9.5° C. PCM (Crodatherm is a trademark of Croda Europe Ltd.)

The second PCM material may comprise a plant-based organic PCM microencapsulated in an acrylic shell, such as Nextek 37D™ MicroEncapsulated Phase Change Material (mePCM) (Nextek 37D™ is a trademark of Microtek Labaoratories, Inc.).

The thickening agent may in some embodiments comprise a tri-block co-polymer such as styrene-ethyl-butylene-styrene (SEBS) or a di-block copolymer such as styrene-ethylene-propylene (SEP). In particular, the thickening agent may comprise Kraton™ G1651HU, which is an SEBS composition, 30% styrene, linear, powder (1800 cp, 10% wt in Toluene at 25° C. (Kraton™ G1651HU is a trademark of Kraton Corporation)

The surfactant may comprise polysorbate 80, such as Span™ 80, which is a biodegradable surfactant based on a natural fatty acid (oleic acid) and sugar alcohol sorbitol. (Span™ is a trademark of Croda Industrial Chemicals.) The surfactant is used in a very small weight percentage in the range of 0.25% to 0.5% by weight. It is noted that other shorter chain polysorbate surfactants, such as polysorbate 20 were tested without success. While these other surfactants sufficiently suspended the mePCM in the liquid PCM, they also altered the phase change temperature of the materials as part of the heating and suspension process making the resulting PCM unsuitable for the intended purpose and temperature profile. While the specific mechanism is unknown the shorter chain polysorbate sufficiently affect the underlying chemical nature of the PCM's and are not suitable for purposes of the present invention.

The dual PCM liquid suspension may in some embodiments comprise 66% to 79% by weight of the first phase change material in liquid form having a phase change temperature between 8° C. and 15° C., 15% to 30% by weight of the second phase change material in microencapsulated form having a phase change temperature between 32° C. and 37° C., 4% to 6% by weight of the thickening agent and 0.25 to 0.50% by weight of the surfactant.

In some embodiments, the PCM mixture is preconditioned at a temperature between 15° C. and 25° C.

In an exemplary embodiment, the first phase change material has a phase change temperature of about 9.5° C., and the second phase change material has a phase change temperature of about 37° C., and the PCM mixture is preconditioned at a temperature between 20° C. and 25° C.

Exemplary formulations and methodology are outlined in the following examples.

### Example 1

### Chemicals:

Liquid 9.5° C. PCM (Crodatherm 9.5° C. PCM)
Microencapsulated 37° C. PCM (Microtek Laboratories, MPCM37C, Wet Cake form (24% by weight water (76% solids per CoA).
Thickening agent (Kraton G1651HU: SEBS, 30% Styrene, Linear, Powder (1800 cp, 10% wt in Toluene at 25° C.)
Surfactant—Polysorbate 80 (Span 80)

### Methodology

A 250 ml beaker was charged with 120.0 grams of liquid PCM (Crodatherm 9.5° C.). After the addition of the liquid PCM the mixture was stirred at about 110-120 RPM. To the stirring PCM suspension 7.9 grams of Kraton G1651HU was slowly added over a period of about 1 minute. After the addition of the G1651HU, the mixture was heated while stirring, until the mixture formed a clump free homogenous solution with the liquid PCM (60° C.). Immediately after forming a solution, 30.0 grams of the solid PCM (MPCM Nextek 37C) was slowly added to the solution over a period of about 1 minute. After the addition of the solid PCM, the solution was stirred for about 5 minutes and it was observed that the Solid PCM was not dispersing into the solution, instead it formed clumps. To suspend the solid, 0.08 grams of Polysorbate 80 was added. It took almost 15 minutes for the material to disperse into the liquid PCM. After the material dispersed, stirring was stopped, and the mixture was left to cool to ambient temperatures prior to making observations.

### Results for Example 1

The final product has the appearance of a thick liquid that resembles Elmer's glue and has similar viscosity to that glue

The material flows well and can easily be filled using a filling machine for semi viscous liquids.

No settling of the solid PCM was observed while standing hot or while cooling.

The material does not separate out, even after standing at ambient temperatures for several days

### Example 2

### Chemicals:

Liquid 9.5° C. PCM (Crodatherm 9.5° C. PCM)
Microencapsulated 37° C. PCM (Microtek Laboratories, MPCM37C, Wet Cake form (24% by weight water (76% solids per CoA).
Thickening agent (Kraton G1651HU: SEBS, 30% Styrene, Linear, Powder (1800 cp, 10% wt in Toluene at 25° C.)
Surfactant—Polysorbate 80 (Span 80)

### Methodology

A 250 ml beaker was charged with 120.0 grams of the liquid PCM (Crodatherm 9.5° C.). After the addition of the liquid PCM the mixture was stirred at about 110-120 RPM. To the rapidly stirring PCM, 7.9 grams of Kraton G1651HU was slowly added over a period of about 1 minute. After this addition, 0.08 grams of Polysorbate 80 was added. This mixture was stirred until the Polysorbate 80 was evenly dispersed (about 5 minutes). To the stirring mixture, 30.0 grams of the solid PCM was slowly added over a period of about 1 minute. After all three components were added, the rapidly stirring mixture was heated until a temperature of 60° C. was achieved. Once 60° C. was achieved the mixture was kept at this temperature for one hour. After an hour, the solid material had dispersed, stirring was stopped, and the mixture was left to cool to ambient temperatures prior to making observations.

### Results for Example 2

The final product has the appearance of a thick liquid that resembles Elmer's glue and has similar viscosity to that glue.

The material flows well and can easily be filled using a filling machine for semi viscous liquids.

No settling of the solid PCM was observed while standing hot or while cooling.

The material does not separate out even after standing at ambient temperatures for several days.

The example #1 process can be modified so that all components are blended prior to heating and thus completed in less time.

### Example 3

### Chemicals:

Liquid 9.5° C. PCM (Crodatherm 9.5° C. PCM)
Microencapsulated 37° C. PCM (Microtek Laboratories, MPCM37C, Wet Cake form (24% by weight water (76% solids per CoA).
Thickening agent (Kraton G1651HU: SEBS, 30% Styrene, Linear, Powder (1800 cp, 10% wt in Toluene at 25° C.)
Surfactant—Polysorbate 80 (Span 80)

### Methodology

A 12 Liter reactor was charged with 6,068.0 grams of the liquid PCM (Crodatherm 9.5° C.). After the addition of the liquid PCM the mixture was stirred at about 110-120 RPM. To the rapidly stirring PCM, 400.0 grams of Kraton G1651HU was slowly added over a period of about 10 minutes. After the addition of the G1651HU, 4.0 grams of Polysorbate 80 was added. This mixture was left to stir until the Polysorbate 80 was evenly dispersed (about 5 minutes). To the rapidly stirring mixture, 1513.0 grams of the solid PCM (MPCM37C) was slowly added over a period of about 15 minutes. After all three components were added the rapidly stirring mixture was then heated until a temperature of 60° C. was achieved. When the mixture reached 60° C., it was kept at this temperature for one hour. After an hour, the dispersion appeared homogenous, so stirring was stopped, and the mixture was left to cool to ambient temperatures prior to making observations.

### Results for Example 3

The final product has the appearance of a thick liquid that resembles Elmer's glue and has similar viscosity to that glue.

The material flows well and can easily be filled using a filling machine for semi viscous liquids.

No settling of the solid PCM was observed while standing hot or while cooling.

The material does not separate out even after standing at ambient temperatures for several days

### Freeze/Thaw Testing

### Test Subjects:

(1) 76.0% wt Crodatherm 9.5, 5.0% wt Kraton G1651HU, 0.06% wt Polysorbate 80, and 19.0% wt MPCM 37C wet cake made using sequential addition of components (Example #1).
(2) 76.0% wt Crodatherm 9.5, 5.0% wt Kraton G1651HU, 0.06% wt Polysorbate 80, and 19.0% wt MPCM 37C we cake made by single addition of components (Example #2).

### Equipment:

Test Equity Model 140 environmental chamber, with temperature capability from −73° C. to +175° C., including F4T programmable controller, and four shelves, with a capacity of 4 cubic feet (ID 22″W×18″H×18″D). The temperature uniformity in the working space of the chamber is +/−0.5° C.

Aluminum weighing pans.

### Procedure:

The products from Examples #1, and #2 were placed into an Aluminum weighing plans and subjected to the following freeze/thaw cycle: −20° C. for 30 minutes, followed by +40° C. for 30 minutes. The cycle is sufficient to fully freeze/thaw the sample in the pans during each cycle. The test chamber was programmed to repeat the above cycle 20 times.

### Results for Testing

After 20 freeze/thaw cycles in the M140 environmental chamber, both PCM samples survived the tests, with no microencapsulated PCM settling out.

### CONCLUSION

The 5% wt Kraton G1651HU sample of Liquid PCM blended with MPCM37D microencapsulated PCM survived 20 freeze/thaw cycles with no microencapsulated PCM settling out.

It can therefore be seen that the present disclosure provides a novel dual-PCM liquid suspension for use in the PCM containers which can be filled using conventional filling equipment, and the filled bottles preconditioned and stored at a single temperature thus reducing energy consumption and storage requirements. For these reasons, the instant invention is believed to represent a significant advancement in the art which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed is:

1. A phase change material comprising:
a first phase change material in liquid form having a first phase change temperature;
a second phase change material in microencapsulated form having a second phase change temperature;
a thickening agent; and
a surfactant,
wherein said first and second phase change materials, said thickening agent and said surfactant are blended in a homogenous mixture and heated for a period of time.

2. The phase change material of claim 1 wherein said first phase change material is selected from the group consisting of: water-based PCMs; plant-based organic PCMs, paraffin based PCMs and salt hydrate based PCM's.

3. The phase change material of claim 1 wherein said second PCM material comprises a plant-based organic PCM microencapsulated in an acrylic shell.

4. The phase change material of claim 2 wherein said second PCM material comprises a plant-based organic PCM microencapsulated in an acrylic shell.

5. The phase change material of claim 1 wherein said first phase change material has a phase change temperature of about 9.5° C.

6. The phase change material of claim 1 wherein said second phase change material has a phase change temperature of about 37° C.

7. The phase change material of claim 5 wherein said second phase change material has a phase change temperature of about 37° C.

8. The phase change material of claim 2 wherein said liquid PCM comprises an organic ester.

9. The phase change material of claim 4 wherein said liquid PCM comprises an organic ester.

10. The phase change material of claim 1 wherein said surfactant is polysorbate 80.

11. The phase change material of claim 4 wherein said surfactant is polysorbate 80.

12. A method for making a dual phase change material liquid suspension comprising the steps of:
providing a first phase change material in liquid form having a first phase change temperature;
providing a second phase change material in microencapsulated form having a second phase change temperature;
providing a thickening agent;
providing a surfactant;
stirring the first phase change material;
adding the thickening agent to the first phase change material and stirring until evenly dispersed;
heating the first change material and thickening agent to a predetermined temperature while stirring;
adding the second phase change material while stirring and maintaining said temperature;
adding the surfactant while stirring and maintaining said temperature; and
cooling to ambient temperature.

13. The method of claim 12 wherein the predetermined temperature is about 60° C.

14. The method of claim 12 wherein said surfactant is polysorbate 80.

15. The method of claim 13 wherein said surfactant is polysorbate 80.

16. A method for making a dual phase change material liquid suspension comprising the steps of:
providing a first phase change material in liquid form having a first phase change temperature;
providing a second phase change material in microencapsulated form having a second phase change temperature;
providing a thickening agent;
providing a surfactant;
stirring the first phase change material;
adding the thickening agent to the first phase change material and stirring until evenly dispersed;
adding the surfactant and stirring until evenly dispersed;
adding the second phase change material and stirring until evenly dispersed;
heating the dispersed materials to predetermined temperature while stirring;
maintaining said temperature while stirring for a period of time and cooling to ambient temperature.

17. The method of claim 16 wherein the predetermined temperature is about 60° C.

18. The method of claim 16 wherein said surfactant is polysorbate 80.

19. The method of claim 17 wherein said surfactant is polysorbate 80.
